(19) United States
(12) Patent Application Publication
(10) Pub. No.: US 2018/0149926 A1
(43) Pub. Date: May 31, 2018

(54) METHOD FOR MANUFACTURING LIQUID CRYSTAL DEVICE AND LIQUID CRYSTAL DEVICE MANUFACTURED THEREFROM

(71) Applicant: BenQ Materials Corporation, Taoyuan (TW)

(72) Inventor: Chun-Chieh Yi, Taoyuan City (TW)

(21) Appl. No.: 15/414,360

(22) Filed: Jan. 24, 2017

(30) Foreign Application Priority Data
Nov. 29, 2016 (TW) 105139188

(51) Int. Cl. G02F 1/1337; G02F 1/1339; B32B 17/00; B32B 27/00; B32B 37/24

(52) U.S. Cl. CPC G02F 1/133711; B32B 2037/243; G02F 1/133788; B32B 17/00; B32B 27/00; B32B 37/24; G02F 2202/025; G02F 2202/04; G02F 2202/28; G02F 2001/13398; B32B 2307/412; B32B 2255/20; B32B 2307/202; B32B 2315/08; B32B 2457/202; G02F 1/13392

(57) ABSTRACT

The invention provides a method for manufacturing an liquid crystal device to avoid sedimentation problem of spacers and provide a liquid crystal device with better optical properties, comprising the steps of: providing a first substrate; coating an aligning solution on the first substrate, wherein the aligning solution comprises a liquid crystal alignment treatment agent, a solvent and a plurality of spacers; curing the aligning solution to form a first alignment layer; coating a liquid crystal solution on the first alignment layer to form a liquid crystal layer; providing a second substrate; and adhering the second substrate to the first substrate.

This application claims the benefit of TW application No. 105139188, filed on Nov. 29, 2016, and the entirety of which is incorporated by reference herein.

### BACKGROUND OF THE INVENTION

### Field of the Invention

The present disclosure relates to a method for manufacturing a liquid crystal device and particularly, a method for manufacturing a liquid crystal device preventing the spacers in the liquid crystal device from uneven distribution or sedimentation.

### Description of the Related Art

With the increasing demand for smart windows, the application of light regulating devices or optical switchable devices is consequently developed. Recently, the liquid crystal (LC) switchable display utilizing polymer dispersed liquid crystal (PDLC) or polymer network liquid crystal (PNLC) has been on the market. The LC switchable display is switchable to exhibit transparent state or opaque state by applying electric field to change the orientation of the liquid crystal molecules orderly or randomly. This LC switchable display is configured by a LC layer disposed between a pair of substrates with electrodes and driven by applying a predetermined voltage therebetween to switch the orientation of the liquid crystal molecules to exhibit transparent state or opaque state on the switchable display so that to provide a fast switching time and instant privacy. This LC switchable display can be packaged by glass for acting as a construction materials or flexible material for attaching onto existing windows, glass partitions without changing the existing construction.

It is known that the PDLC or PNLC switchable display can work as direct mode LC switchable display or reverse mode LC switchable display. In a direct mode LC switchable display, the liquid crystal molecules are oriented randomly in the absence of applied voltage to cause the light scattering to appear opaque and are oriented in order under applying a proper voltage to appear transparent. However, it is necessary to apply a voltage to maintain the transparent appearance when the direct mode LC switchable display is worked. Thus, the working cost is increased since extra voltage is necessary to apply to main the transparent state of the LC switchable device used as a window for a long time.

Different from the direct mode LC switchable display, the reverse mode LC switchable display is normally transparent in the absence of applied voltage and becomes opaque in the presence of applied voltage. The common reverse mode LC switchable display is configured by disposing a layer of liquid crystal of 6-10 μm thickness, UV cured resin and spacers between two conductive indium-tin oxide glasses (ITO Glass) with alignment layers formed thereon. The transmittance of the LC switchable display will increase along with the increasing addition amount of the resin. However, as the addition amount of the resin is increased, the driving voltages for switching the display from transparent state to opaque state will thus be increased. As the addition amount of the resin is decreased, the spacers disposed between the two conductive ITO glasses cannot be fixed properly when the liquid crystal device is manufactured by roll to roll process, which will result in the spacers being unevenly distributed or sedimented in the device and subsequently affect the appearance of the device.

For improving the sedimentation of the spacers during the process of manufacturing the devices, it has been suggested to use photo-spacers processed by photolithography. However, the process for preparing photo-spacers comprises the steps of coating, exposing, developing, and baking, which are complicated and costly. Furthermore, the photo-spacers are not suitable being used in roll-to-roll process for wide film production.

Accordingly, a novel method for manufacturing a liquid crystal device with better optical properties suitable for the large-scaled roll-to-roll process and free from uneven distribution and sedimentation of spacers therein are highly expected.

### SUMMARY OF THE INVENTION

The present disclosure is to provide a novel method for manufacturing a liquid crystal device, wherein the spacers used between the two substrates can be fixed in the alignment layer when the alignment solution is cured to form the alignment layer. Thus, the optical properties of the liquid crystal device can be enhanced by preventing the spacers from uneven distribution and sedimentation therein.

An aspect of the present disclosure is to provide a method for manufacturing a liquid crystal device. The present method comprises the steps of providing a first substrate with a first conductive layer formed thereon; coating an alignment solution on the first substrate, wherein the alignment solution comprises a liquid crystal alignment treatment agent, a solvent and a plurality of spacers; curing the alignment solution to form a first alignment layer; coating a liquid crystal solution on the first alignment layer to form a liquid crystal layer, wherein the liquid crystal solution comprises a liquid crystal material; providing a second substrate; and adhering the second substrate to the first substrate.

In a preferred embodiment of the present disclosure, the liquid crystal alignment treating agent is selected from one of the group consisting of acrylic polymers, methacrylic polymers, novolak resins, polyhydroxystyrenes, polyimide precursors, polyimides, polyamides, polyesters, celluloses and polysiloxanes, or the combinations thereof.

In a preferred embodiment of the present disclosure, the alignment solution comprises 1 to 10 parts by weight of the liquid crystal alignment treatment agent per 100 parts by weight of the alignment solution.

In a preferred embodiment of the present disclosure, the alignment solution comprises 0.1 to 0.3 parts by weight of the spacers per 100 parts by weight of the alignment solution.

In a preferred embodiment of the present disclosure, the particle size of the spacers is between 6 μm to 14 μm.

In a preferred embodiment of the present disclosure, the step of curing the alignment solution is conducted by thermal cure treatment.

In a preferred embodiment of the present disclosure, the thermal curing treatment is proceeded under the temperature between 60° C. to 160° C. for 10 minutes to 40 minutes.

In a preferred embodiment of the present disclosure, the liquid crystal solution further comprises a curable resin, a dye or an initiator.

In a preferred embodiment of the present disclosure, the curable resin is selected from one of a group consisting of 1,6-hexanediol diacrylate (HDDA), triethylene glycol diacrylate (TEGDA), 1,9-nonanediol diacrylate (1,9-NDDA), dipropylene glycol diacrylate (DPGDA), ethoxylated bisphenol A diacrylate (BPA4EODA), hydroxypivalylhydroxypivalatediacrylate (HPHPDA) and polyethylene glycol (200) diacrylate (PEG(200)DA), or the combinations thereof.

In a preferred embodiment of the present disclosure, the liquid crystal solution comprises 75 to 95 parts by weight of the liquid crystal material per 100 parts by weight of the liquid crystal solution.

In a preferred embodiment of the present disclosure, the liquid crystal solution comprises 0 to 25 parts by weight of the curable resin per 100 parts by weight of the liquid crystal solution.

In a preferred embodiment of the present disclosure, the liquid crystal solution comprises 0 to 5 parts by weight of the dye per 100 parts by weight of the liquid crystal solution.

In a preferred embodiment of the present disclosure, the second substrate comprises a second alignment layer formed thereon and the second alignment layer is faced to the first alignment layer.

In a preferred embodiment of the present disclosure, the first substrate and the second substrate are independently a glass substrate or a plastic substrate.

A further aspect of the present disclosure is to provide a liquid crystal device which is manufactured by the above-mentioned methods.

### BRIEF DESCRIPTION OF THE DRAWINGS

FIGS. 1A to 1F are cross-sectional views of the process for manufacturing a liquid crystal device of a preferred embodiment of the present disclosure.

FIG. 2 is a cross-sectional view of the liquid crystal device of another preferred embodiment of the present disclosure.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In the following description, numerous specific details are described in detail in order to enable the reader to fully understand the following examples. However, embodiments of the present disclosure may be practiced in case no such specific details. In other cases, in order to simplify the drawings, the structure of the apparatus known only schematically depicted in drawings.

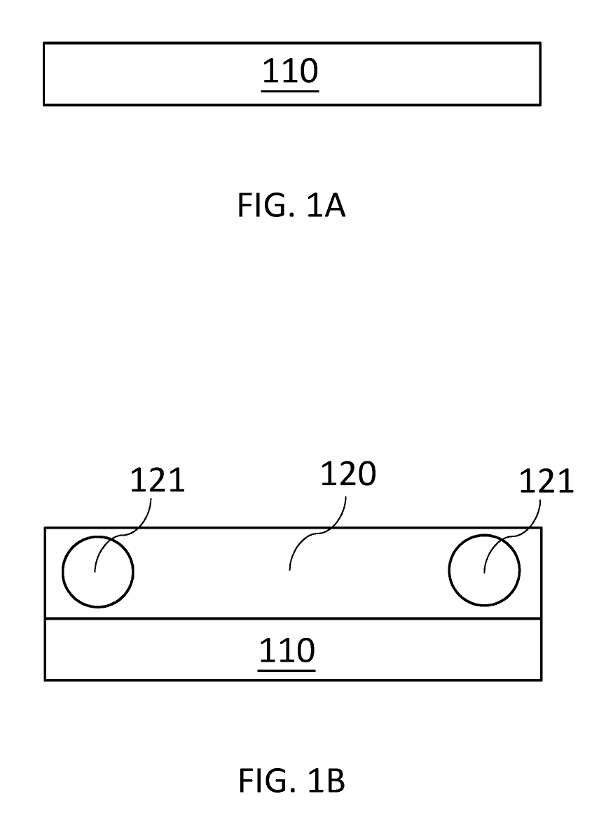

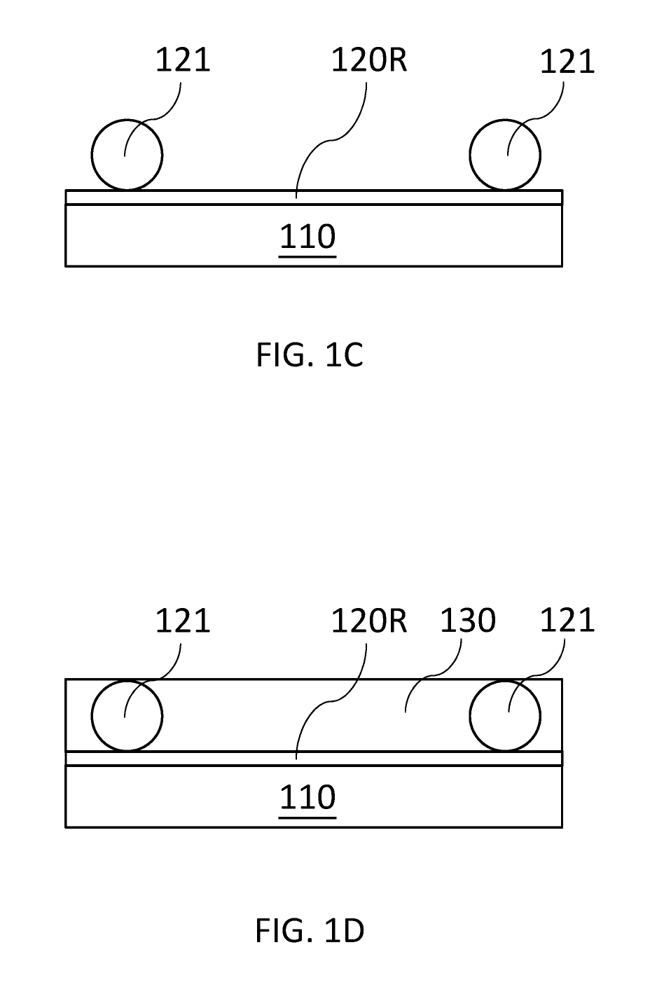

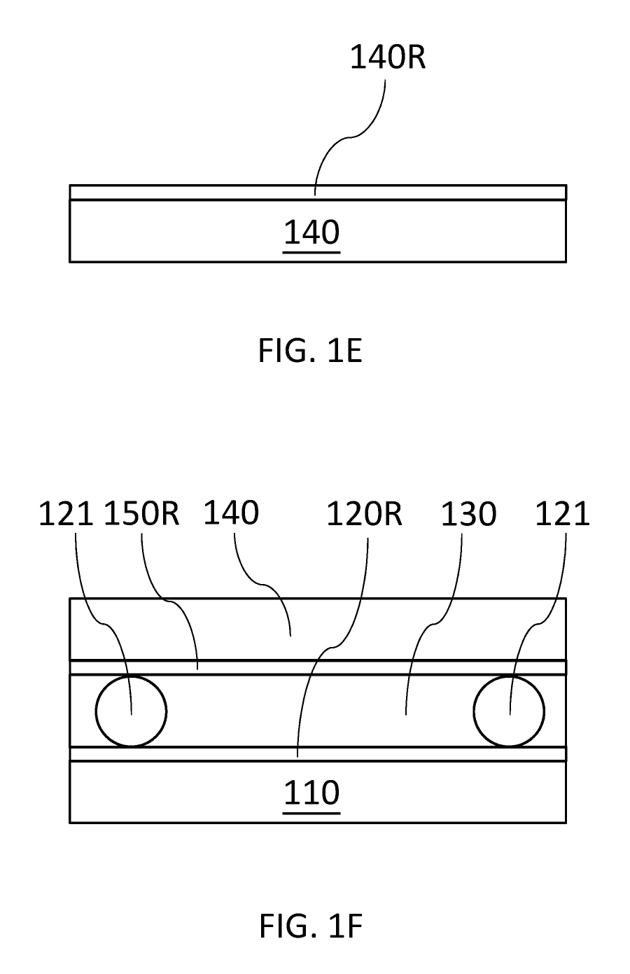

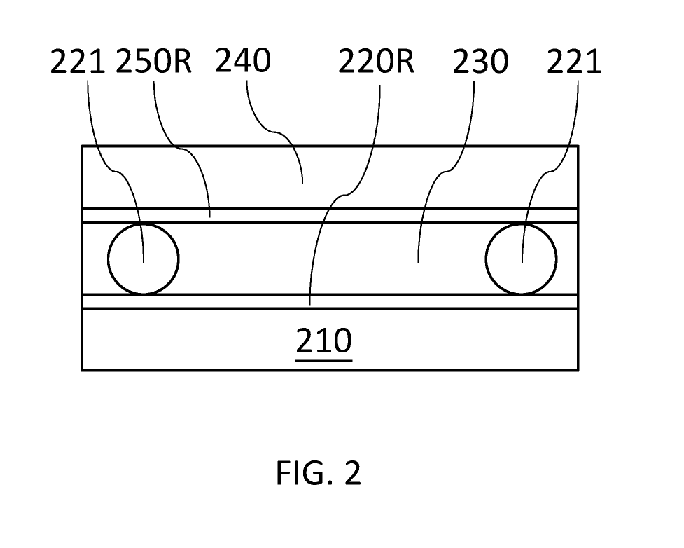

An aspect of the present disclosure is to provide a method for manufacturing a liquid crystal device. Referring FIGS. 1A to 1F, the drawings show the cross-sectional views of the process for manufacturing a liquid crystal device of a preferred embodiment of the present disclosure.

Firstly, as illustrated in FIG. 1, the first substrate 110 is provided with a first conductive layer (not shown) formed thereon. Materials suitably used as the first substrate 110 of the present liquid crystal device can be high transparent materials known in the related art without any particular limited. The materials can independently be, for example, glass substrate or plastic substrate. The plastic substrate of this present disclosure can be made of plastic materials including but not limited to, for example, triacetate cellulose (TAC), cyclo-olefin polymer (COP) of norbornene derivative, polymethylmethacrylate (PMMA), polycarbonate (PC), polyethylene (PE), polypropylene (PP), polyvinyl alcohol (PVA), diacetyl cellulose (DAC), polyacrylates (Pac), polyether sulfone (PES), polyetheretherketone (PEEK), polyphenylene sulfide (PPSU), polyetherimide (PEI), polyethylene naphthalate (PEN), poly(ethylene terephthalate) (PET), polyimide (PI), polysulfone (PSF), polyarylate (PAR) or amorphous fluorine resin.

The first conductive layer of the first substrate 110 can be formed by depositing, such as, a conduction polymer, a conductive metal, a conductive nanowire or indium-tin oxide (ITO) on the first substrate 110 for electrically driving the motion of the liquid crystal molecules in liquid crystal device. In a preferred embodiment of the present disclosure, the first substrate 110 is a glass substrate with an indium-tin oxide formed thereon as the first conductive layer.

Referring to FIG. 1B, an alignment solution 120 is coated on the first substrate 110. The alignment solution 120 comprises a liquid crystal alignment treatment agent, a solvent and a plurality of spacers 121. The alignment solution 120 can be coated by for example slit coating process, roller coating process or die coating process, but not limited thereto.

The liquid crystal alignment treatment agent can be oriented by radiation or rubbing first, then the liquid crystal compounds are oriented in a predetermined direction via interaction therebetween, such as anisotropic interaction. The liquid crystal alignment treating agent can comprise a single-molecule compound, a monomer compound, an oligomer compound or a polymer. The liquid crystal alignment treatment agent suitable for this present disclosure can be but not limited to acrylic polymers, methacrylic polymers, novolak resins, polyhydroxystyrenes, polyimide precursors, polyimides, polyamides, polyesters, celluloses, polysiloxanes or the combinations thereof. The solvent can enhance the film-forming ability and leveling of the liquid crystal alignment treating agent coating. The solvent which can dissolve the liquid crystal alignment treating agent is suitable for this present disclosure, for example, 1-hexanol, cyclohexanol, 1,2-ethylene glycol, 1,2-propylene glycol, propylene glycol monobutylether, ethylene glycol butylether, dipropylene glycol dimethylether, cyclohexanone, cyclopentanone, N-methyl-pyrrolidone, N-ethyl-pyrrolidone, and γ-butyrolactone or the combinations thereof. In a preferred embodiment of the present disclosure, the solvent is N-methyl-pyrrolidone, and the liquid crystal alignment treatment agent is polyimide. In a preferred embodiment of the present disclosure, the alignment solution 120 comprises 1 to 10 parts by weight of the liquid crystal alignment treatment agent and 90 to 99 parts by weight of solvent per 100 parts by weight of alignment solution 120.

The spacers 121 are disposed between the two substrates to hold the cell gap therebetween. The spacers 121 can be consisted of those spacers made of glass or resin used in conventional liquid crystal device. The particle size of the spacers 121 is dependent on the cell gap size required by the liquid crystal device. In a preferred embodiment of the present disclosure, the particle size of the spacers 121 is between 6 μm to 14 μm, and the alignment solution 120 comprises 0.1 to 0.3 parts by weight of spacers 121 per 100 parts by weight of the alignment solution 120.

After the alignment solution 120 is coated on the substrate 110, the alignment solution 120 is cured to form a first alignment layer 120R, as shown in FIG. 1C. When curing the alignment solution, the spacers 121 are simultaneously cured to fix on the first alignment layer 120R, and thus the spacers 121 can evenly distributed therein without sedimentation. The alignment solution 120 can be cured by thermal curing or photo curing. In a preferred embodiment of the present disclosure, the alignment solution 120 is thermal cured at the temperature between 60° C. to 160° C. for about 10 minutes to 40 minutes. Next, an alignment treatment can be optionally conducted to the cured first alignment layer 120R. The alignment treatment can be, for example, micro-scratch alignment treatment, rubbing treatment, photo-alignment, SiO₂ evaporation or ion beam alignment. The alignment treatment is not critical to the protection scope claimed in the invention. Any method for forming the alignment layer commonly used in the related art is within the scope of the present disclosure.

After forming the first alignment layer 120R, a liquid crystal solution is coated on the first alignment layer 120R to form a liquid crystal layer 130, as shown in FIG. 1C. The liquid crystal solution comprises a liquid crystal material. The liquid crystal materials suitable for this present disclosure can be a smectic liquid crystal, a nematic liquid crystal, or a cholesteric liquid crystal. When applying a voltage, the orientation of the liquid crystal molecules will be changed in order to switch the modes of liquid crystal device. In a preferred embodiment of the present disclosure, the liquid crystal solution comprises 75 to 95 parts by weight of liquid crystal material per 100 parts by weight of liquid crystal solution.

In a preferred embodiment of the present disclosure, the liquid crystal solution can optionally further comprises a curable resin, a dye or an initiator.

The transmittance of the liquid crystal device in transparent state can be enhanced by adding curable resin into the liquid crystal solution. Suitable curable resins are those which can be dissolved in liquid crystal and be polymerized by any reaction mode to form cured resin. In a preferred embodiment of the present disclosure, the weight average molecular weight of the curable resin is less than 400 and preferably, the weight average molecular weight of the curable resin is about 200 to 400. The higher molecular weight of the curable resin will result in white points in the transparent state of the liquid crystal device due to poor dispersion thereof. The curable resins suitable for this present disclosure can be, for example, 1,6-hexanediol diacrylate (HDDA), triethylene glycol diacrylate (TEGDA), 1,9-nonanediol diacrylate (1,9-NDDA), dipropylene glycol diacrylate (DPGDA), ethoxylated bisphenol A diacrylate (BPA4EODA), hydroxypivalylhydroxypivalatediacrylate (HPHPDA), polyethylene glycol (200) diacrylate (PEG(200)DA) or the likes and the combinations thereof, but not limited thereto. In a preferred embodiment of the present disclosure, the liquid crystal solution comprises 0 to 25 parts by weight of the curable resin per 100 parts by weight of liquid crystal solution.

The suitable dyes can be polychroic dyesordichroic dyes, which can be aligned in parallel with the liquid crystal molecules. When the dye with rod-like structure is added into the liquid crystal, the dye molecules will be aligned with the liquid crystal molecules under the switch of applied voltage to exhibit colored state or transparent state. The dyes suitable for this present disclosure can be, for example, arylazodyes, polyazo aryl dyes, non-ionic azo dyes, anthraquinone dyes or the combination thereof. In a preferred embodiment of the present disclosure, the dye is arylazodye. The liquid crystal solution comprises 0 to 5 parts by weight of dye per 100 parts by weight of liquid crystal solution 130.

The liquid crystal solution can be further blend with an initiator. The initiator can be but not limited to any suitable initiators known in the related art, such as photoinitiator or thermalinitiator. In a preferred embodiment of the present disclosure, the initiator can be photoinitiator. The photoinitiator can be 1-hydroxycyclohexyl phenyl ketone. The liquid crystal solution comprises 0 to 3 parts by weight of photoinitiator per 100 parts by weight of liquid crystal solution.

Referring to FIG. 1E, a second substrate 140 with a second conductive layer (not shown) is provided. The second substrate 140 suitable being used in the present liquid crystal device can be any conventional materials with high transparency such as glass substrate or plastic substrate, but not limited thereto. The plastic substrate can be made of, for example, triacetate cellulose (TAC), cyclo-olefin polymer (COP) of norbornene derivative, polymethylmethacrylate (PMMA), polycarbonate (PC), polyethylene (PE), polypropylene (PP), polyvinyl alcohol (PVA), diacetyl cellulose (DAC), polyacrylates (Pac), polyether sulfone (PES), polyetheretherketone (PEEK), polyphenylene sulfide (PPSU), polyetherimide (PEI), polyethylene naphthalate (PEN), poly (ethylene terephthalate) (PET), polyimide (PI), polysulfone (PSF), polyarylate (PAR) or amorphous fluorine resin, but not limited thereto.

The second conductive layer (not shown) of the second substrate 140 can be formed by deposition, such as, by depositing a conduction polymer, a conductive metal, a conductive nanowire or indium-tin oxide (ITO) on the substrate for electrically driving the action of the liquid crystal in liquid crystal device. In a preferred embodiment of the present disclosure. The second substrate 140 can be a glass substrate with an indium tin oxide as the second conductive layer. Optionally, a second alignment layer 150R can be formed by any conventional method on the second substrate 140.

Next, the second substrate 140 is adhered to the first substrate 110, and the second alignment layer 150R of the second substrate 140 is faced to the first alignment layer 120R. Thus, the liquid crystal layer 130 is disposed between the first substrate 110 and the second substrate 140, as shown in FIG. 1F.

In a preferred embodiment of the present disclosure, after the first substrate 110 is adhered to the second substrate 140, a photo cure treatment can be optionally conducted to the liquid crystal layer 130. The radiation of the photo cure treatment is at about 1100 mj/cm² to about 1200 mj/cm². Optionally, the first alignment layer 120R and the second alignment layer 150R can be photo aligned via the photo cure treatment.

In the embodiment of the present disclosure, the spacers 121 are fixed on the first alignment layer 120R by coating the alignment solution 120 mixed with the spacers 121 on the first substrate 110 and curing afterward. The present method can prevent the spacers 121 from being unevenly dispersed or sedimented in the liquid crystal solution as processed in the prior art whose spacers are mixed into the liquid crystal solution.

Another aspect of the present disclosure is to provide a liquid crystal device manufactured by the method disclosed above. In a preferred embodiment of the present disclosure, when no voltage is applied to the liquid crystal device, the liquid crystal molecules in the liquid crystal layer 130 of the liquid crystal device will be vertically aligned in the same direction due to the alignment of the first alignment layer 120R and the second alignment layer 150R. Thus, the incident light will pass through the liquid crystal device to exhibit transparency. In a preferred embodiment of this present disclosure, the liquid crystal device exhibits transparent because the liquid crystal molecules in the liquid crystal layer 130 of the liquid crystal device are aligned along with the same direction by the first alignment layer 120R and the second alignment layer 150R when no voltage is applied which allows the incident light to pass through the liquid crystal device; the liquid crystal device exhibits opaque because the liquid crystal molecules in the liquid crystal layer 130 of the liquid crystal device are randomly oriented when a certain voltage is applied to the liquid crystal device which allows no incident light to pass through the liquid crystal device since the incident light is strongly scattered. In another embodiment of this present disclosure, the liquid crystal device exhibits opaque because the liquid crystal molecules in the liquid crystal layer 130 of the liquid crystal device are randomly oriented when no voltage is applied to the liquid crystal device which allows no incident light to pass through the liquid crystal device since the incident light is strongly scattered; the liquid crystal device exhibits transparent because the liquid crystal molecules in the liquid crystal layer 130 of the liquid crystal device are aligned along with the same direction by the first alignment layer 120R and the second alignment layer 150R when a certain voltage is applied which allows the incident light to pass through the liquid crystal device.

Accordingly, the liquid crystal device manufacturing by the method of the present disclosure prevent the spacers 121 from being sedimented or unevenly dispersed so as to provide a superior optical properties. Furthermore, since the photolithography process for treating the photo-spacers is eliminated, the present manufacturing method can be simplified and suitably used to roll-to-roll process. The liquid crystal device of the present disclosure can exhibit transparent state or opaque state and thus, can apply as an optical modulator for used as smart window, privacy protecting window or a flexible display device, but not limited thereto.

The following Examples are presented to further illustrate and embody the present disclosure but not intended to limit to thereto.

### Example 1: Preparation of the Liquid Crystal Device

0.03 g of spacers with a particle size of 6 μm (N3N-14 μm, commercially available from UBE EXSYMO, Japan) and 10 g of polyimide solution (DA-9003, solid content of about 2%, in a solvent of N-methyl-pyrrolidone, commercially available from Daxin Material, Taiwan) were mixed and stirred for 24 hours. The resulted mixture was coated with a thickness of 16 μm on an ITO transparent electrode layer of a first ITO glass substrate and heated to 150° C. for 30 minutes to form a first alignment layer.

Next, 0.009 g of photoinitiator 1-Hydroxycyclohexyl phenyl ketone, 0.45 g of UV resin 1,6-hexanediol diacrylate (EM221, commercially available from Eternal Materials, Taiwan), 0.4 g of a mixture of 4-(4-butylphenylazo) phenol and Sudan black (commercially available from Imperial Chemical Industries (ICI), UK) and 9.15 g of liquid crystal compound (MJT510200-100, commercial available from HECHENG, China) were mixed to form a liquid crystal solution. Then, the liquid crystal solution was coated on the first alignment layer.

A second ITO glass substrate with a second alignment layer formed thereon was provided, and adhered to the first ITO glass substrate by facing the second alignment layer toward the first alignment layer of the first ITO glass substrate to obtain a liquid crystal device.

Next, the obtained liquid crystal device is radiated by UV radiation (TL-K 40 W, commercial available from Philips, Germany) to conduct the aligning and curing treatment. The UV radiation was conduct at a wavelength of 365 nm for 300 seconds.

### Example 2: Preparation of the Liquid Crystal Device

0.01 g of spacers with a particle size of 6 μm (N3N-6 μm, commercially available from UBE EXSYMO, Japan) and 10 g of polyimide solution (DA-9003, solid content of about 4% in a solvent of N-methyl-pyrrolidone, commercially available from Daxin Material, Taiwan) were mixed and stirred for 24 hours. The resulted mixture was coated with a thickness of 8 μm on an ITO transparent electrode layer of a first ITO glass substrate and heated to 160° C. for 30 minutes to form a first alignment layer.

Next, 0.2 g of azo dye mixture (commercially available from Hayashibara, Japan) and 9.8 g of liquid crystal compound (MJT510200-100, commercially available from HECHENG, China) were mixed to a liquid crystal solution. The resulted liquid crystal solution was coated on the first alignment layer.

A second ITO glass substrate with a second alignment formed thereon was provided, and adhered to the first ITO glass substrate by facing the second alignment layer toward the first alignment layer of the first ITO glass substrate to obtain a liquid crystal device.

### Example 3: Preparation of the Liquid Crystal Device

0.01 g of spacers with a particle size of 6 μm (N3N-6 μm, commercially available from UBE EXSYMO, Japan) and 10 g of polyimide solution (DA-9003, solid content of about 2% in a solvent of N-methyl-pyrrolidone, commercially available from Daxin Material, Taiwan) were mixed and stirred for 24 hours. The resulted mixture was coated with a thickness of 8 μm on an ITO transparent electrode layer of a first glass substrate, and then heated to 60° C. for 10 minutes and heated to 160° C. for 30 minutes to form a first alignment layer.

Next, 0.005 g of photoinitiator1-Hydroxycyclohexyl phenyl ketone, 2.5 g of UV resin 1,6-hexanediol diacrylate (IM221, commercially available from Eternal Materials, Taiwan) and 7.5 g of liquid crystal compound (MJT510200-100, commercially available from HECHENG, China) were mixed to form a liquid crystal solution. The liquid crystal solution was coated on the first alignment layer.

A second ITO glass substrate with a second alignment layer was provided, and adhered to the first ITO glass substrate by facing the second alignment toward the first alignment layer of the first ITO glass substrate to obtain a liquid crystal device.

The obtained liquid crystal device is radiated by UV radiation (TL-K 40 W, commercial available from Philips, Germany) to conduct the aligning and curing treatment. The UV radiation was conduct at a wavelength of 365 nm for 240 seconds.

### Example 4: Preparation of the Liquid Crystal Device

0.02 g of spacers with a particle size of 9 μm (N5N-9 μm, commercially available from UBE EXSYMO, Japan) and 10 g of polyimide solution (DA-9003, solid content of about 2%, in a solvent of N-methyl-pyrrolidone, commercially available from Daxin Material, Taiwan) were mixed and stirred for 24 hours. The resulted mixture was coated with a thickness of 12 μm on an ITO transparent electrode layer of a first glass substrate, and then heated to 60° C. for 10 minutes and heated to 150° C. for 30 minutes to form a first alignment layer.

Next, 0.02 g of photointiator1-1-Hydroxycyclohexyl phenyl ketone, 1 g of UV resin 1,6-hexanediol diacrylate (EM221, commercially available from Eternal Materials) and 9 g of liquid crystal compound (MJT510200-100, commercially available from HECHENG, China) were mixed to form a liquid crystal solution. The liquid crystal solution was coated on the first alignment layer.

A second ITO glass substrate with a second alignment layer formed thereon was provided, then the second alignment layer was adhered to the first substrate by facing the second alignment layer toward the first alignment layer of the first ITO glass substrate to obtain a liquid crystal device.

The obtained liquid crystal device is radiated by UV radiation (TL-K 40 W, commercial available from Philips, Germany) to conduct the aligning and curing treatment. The UV radiation was conducted at a wavelength of 365 nm for 240 seconds.

TABLE 1
The detailed compositions of Examples 1-4

| | Composition (g) of the | | | Composition (g) of the | | |
|---|---|---|---|---|---|---|
| | liquid crystal layer | | | alignment layer | | |
| | liquid | | | | Alignment | |
| | crystal | | | | treating | |
| Example | material | resin | dye | solvent | agent | Spacers |
| Example 1 | 9.15 | 0.45 | 0.4 | 9.8 | 0.2 | 0.03 |
| | | | | | | (particle |
| | | | | | | size: 14 μm) |
| Example 2 | 9.8 | 0 | 0.2 | 9.6 | 0.4 | 0.01 |
| | | | | | | (particle |
| | | | | | | size: 6 μm) |
| Example 3 | 7.5 | 2.5 | 0 | 9.8 | 0.2 | 0.01 |
| | | | | | | (particle |
| | | | | | | size: 6 μm) |
| Example 4 | 9 | 1 | 0 | 9.8 | 0.2 | 0.02 |
| | | | | | | (particle |
| | | | | | | size: 9 μm) |

### Comparative Example 1: Preparation of the Liquid Crystal Device

A polyimide solution (DA-9003, solid content of 4%, in a solvent of N-methyl-pyrrolidone, commercially available from Daxin Materials) was coated with a thickness of 12 μm on a ITO transparent electrode layer of a first ITO glass substrate, then heated to 60° C. for 10 minutes and heated to 150° C. for 30 minutes to obtain a first alignment layer.

Next, 0.02 g of spacers with a particle size of 14 μm (N3N-14 μm, commercially available from UBE EXSYMO, Japan), 0.009 g of 1-1-Hydroxycyclohexyl phenyl ketone, 0.45 g of 1,6-hexanediol diacrylate (EM221, commercially available from Eternal Materials), 0.4 g of dye (a mixture of 4-aminoazobeneze, Sudan III and Sudan black, commercially available from ICI) and 9.15 g of liquid crystal compound (MJT510200-100, commercially available from HECHENG) were mixed to form liquid crystal solution. The liquid crystal solution was coated on the first alignment layer.

A second ITO glass substrate with a second alignment layer formed thereon was provided, and then adhered to the first ITO glass substrate by facing the second alignment layer toward the first alignment layer of the first ITO glass substrate to obtain a liquid crystal device.

The obtained liquid crystal device is radiated by UV radiation (TL-K 40 W, commercial available from Philips, Germany) to conduct the aligning and curing treatment. The UV radiation was conducted at a wavelength of 365 nm for 240 seconds.

### Comparative Example 2: Preparation of the Liquid Crystal Device

Polyimide solution (DA-9003, solid content of 2%, in a solvent of N-methyl-pyrrolidone, commercially available from Daxin Materials) was coated with a thickness of 10 μm on an ITO transparent electrode layer of a first ITO glass substrate, then heated to 60° C. for 10 minutes and heated to 150° C. for 30 minutes to prepare a first alignment layer.

Next, 0.02 g of spacers with a particle size of 9 μm (N3N-9 μm, commercially available from UBE EXSYMO, Japan), 0.02 g of 1-Hydroxycyclohexyl phenyl ketone, 1 g of 1,6-hexanediol diacrylate (EM221, commercially available from Eternal Materials), and 9 g of liquid crystal compound (MJT510200-100, commercially available from HECHENG) were mixed to form a liquid crystal solution. Then, the liquid crystal solution was coated on the first alignment layer.

A second ITO glass substrate with a second alignment layer formed thereon was provided, then the second alignment layer was adhered to the first ITO glass substrate by facing the second alignment layer toward the first alignment layer of the first ITO glass substrate to obtain a liquid crystal device.

The obtained liquid crystal device is radiated by UV radiation (TL-K 40 W, commercial available from Philips, Germany) to conduct the aligning and curing treatment. The UV radiation was conducted at a wavelength of 365 nm for 240 seconds.

TABLE 2
The compositions of the Comparative Examples1-2

| | Composition (g) of the | | | | | |
|---|---|---|---|---|---|---|
| | liquid crystal layer | | | | Composition (g) of the | |
| | liquid | | | | alignment layer | |
| | crystal | | | | | Alignment |
| Example | material | resin | dye | spacers | solvent | treating |
| Compar- | 9.15 | 0.45 | 0.4 | 0.02 | 9.6 | 0.4 |
| ative | | | | (particle | | |
| Example 1 | | | | size: 14 μm) | | |
| Compar- | 9 | 0 | 1 | 0.02 | 9.8 | 0.2 |
| ative | | | | (particle | | |
| Example 2 | | | | size: 9 μm) | | |

The test method for determining distribution of the spacers

The distribution of the spacers in the liquid crystal device was observed at 100× magnification by an optical microscopy.

The Appearance Test

The appearance is determined by the color change of the liquid crystal device observed by eyes. If an area of more than 1 cm² in the crystal device exhibits uneven color, the uniformity of the device is failure. If none area of more than 1 cm² in the crystal device exhibits uneven color, the uniformity of the device is even.

Test Method of Optical Property

The transmittance of the liquid crystal device is determined by the Spectrum Detective Transmission Meter (SD2400, commercially available from EDTM, USA) in absence of applied voltage.

Test Method of Driving Voltages

The visible light transmittance of the liquid crystal device is determined in the presence of applied 60 V DC by the Spectrum Detective Transmission Meter (SD2400, commercially available from EDTM, USA).

The test results of Examples 1-4 and Comparative Examples 1-2 are shown in Table 2.

TABLE 2
The test results of Examples and Comparative Examples

| | | | 0 V | 60 V |
|---|---|---|---|---|
| | Spacers | | Visible-light | Visible-light |
| | Distribution | Appearance | transmittance | transmittance |
| Example 1 | Even | Even | 39%-40% | 10%-11% |
| Example 2 | Even | Even | 71%-72% | 38%-39% |
| Example 3 | Even | Even | 77%-78% | 32%-33% |
| Example 4 | Even | Even | 77%-78% | 21%-22% |
| Comparative | Sediment | Uneven | 36%-40% | 10%-11% |
| Example 1 | | | | |
| Comparative | Sediment | Uneven | 68%-71% | 21%-22% |
| Example 2 | | | | |

From the test results of Examples 1 to 4 and Comparative Examples 1 and 2, no sedimentation of the spacers occurred in the present liquid crystal devices and the appearance thereof exhibits even color. The present liquid crystal devices apparently provide superior optical properties to that of Comparative Examples 1 to 2. Furthermore, from the test results of the Examples 1 to 4, the transmittance of each present liquid crystal device is in the range of from about 39% to 78% in absence of applied voltage, and decreases to the range of about 10% to 32% in the presence of applied voltage of 60V DC. The present liquid crystal devices can be switched from transparent state to opaque state in the presence of low voltage. The test results shown in Table 2 indicate that the optical properties of the liquid crystal devices manufactured by the method of the present disclosure can be enhanced by avoiding sedimentation or uneven dispersion of the spacers.

Although particular embodiments have been shown and described, it should be understood that the above discussion is not intended to limit the present disclosure to these embodiments. Persons skilled in the art will understand that various changes and modifications may be made without departing from the scope of the present disclosure as literally and equivalently covered by the following claims.

What is claimed is:

1. A method for manufacturing a liquid crystal device comprising:
providing a first substrate with a first conductive layer formed thereon;
coating an alignment solution on the first substrate, wherein the alignment solution comprises a liquid crystal alignment treatment agent, a solvent and a plurality of spacers;
curing the alignment solution to form a first alignment layer;
coating a liquid crystal solution on the first alignment layer to form a liquid crystal layer, wherein the liquid crystal solution comprises a liquid crystal material;
providing a second substrate; and
adhering the second substrate to the first substrate.

2. The method as claimed in claim 1, wherein the liquid crystal alignment treatment agent is selected from one of the group consisting of acrylic polymers, methacrylic polymers, novolak resins, polyhydroxystyrenes, polyimide precursors, polyimides, polyamides, polyesters, celluloses and polysiloxanes, or the combinations thereof.

3. The method as claimed in claim 1, wherein the alignment solution comprises 1 to 10 parts by weight of the liquid crystal alignment treatment agent per 100 parts by weight of the alignment solution.

4. The method as claimed in claim 1, wherein the alignment solution comprises 0.1 to 0.3 parts by weight of the spacers per 100 parts by weight of the alignment solution.

5. The method as claimed in claim 1, wherein the particle size of the spacers is between 6 μm to 14 μm.

6. The method as claimed in claim 1, wherein the alignment solution is thermally cured.

7. The method as claimed in claim 1, wherein the alignment solution is cured at the temperature of about 60° C. to 160° C. for 10 minutes to 40 minutes.

8. The method as claimed in claim 1, wherein the liquid crystal solution further comprises a curable resin, a dye or a initiator.

9. The method as claimed in claim 8, wherein the curable resin is selected from one of a group consisting of 1,6-hexanediol diacrylate (HDDA), triethylene glycol diacrylate (TEGDA), 1,9-nonanediol diacrylate (1,9-NDDA), dipropylene glycol diacrylate (DPGDA), ethoxylated bisphenol A diacrylate (BPA4EODA), hydroxypivalylhydroxypivalatediacrylate (HPHPDA) and polyethylene glycol (200) diacrylate (PEG(200)DA), or the combinations thereof.

10. The method as claimed in claim 1, wherein the liquid crystal solution comprises 75 to 95 parts by weight of the liquid crystal material per 100 parts by weight of the liquid crystal solution.

11. The method as claimed in claim 8, wherein the liquid crystal solution comprises 0 to 25 parts by weight of the curable resin per 100 parts by weight of the liquid crystal solution.

12. The method as claimed in claim 8, wherein the liquid crystal solution comprises 0 to 5 parts by weight of the dye per 100 parts by weight of the liquid crystal solution.

13. The method as claimed in claim 1, wherein the second substrate comprises a second alignment layer, and the second alignment layer and the first alignment layer are faced to each other.

14. The method as claimed in claim 1, wherein the first substrate and the second substrate are independently glass substrate or plastic substrate.

15. A liquid crystal device manufactured by the method as claimed in claim 1.
